(19) United States
(12) Patent Application Publication
(10) Pub. No.: US 2026/0170522 A1
(43) Pub. Date: Jun. 18, 2026

(54) METHOD AND SYSTEM FOR EXTRACTING DEMAND ENHANCING ATTRIBUTES FROM BRAND IMAGERY

(71) Applicant: Cogitaas AVA Pte Ltd, Singapore (SG)

(72) Inventors: Sree Kamal Sen, Mumbai (IN); Balaji Raman, Mumbai (IN)

(21) Appl. No.: 18/981,741

(22) Filed: Dec. 16, 2024

(51) Int. Cl. G06Q 30/0203

(52) U.S. Cl. CPC G06Q 30/0203

(57) ABSTRACT

The present disclosure provides a method for extracting demand enhancing attributes from brand imagery. The method includes receiving consumer data for a representative sample of a target population, wherein the consumer data comprises data on usage, awareness, and associations of multiple brands within a product category. The method further includes regressing the consumer data on usage and brand imagery statements for each brand, wherein the data on usage and brand imagery statements are converted to numerical values. LASSO regression is applied to extract brand attributes that separate a user from a non-user. The attributes are then sorted based on regression coefficients to determine their effectiveness in driving sales. The method enables identification of key attributes that drive product differentiation and growth, bridging the gap between manufacturer perception and consumer perception of a brand.

### FIELD OF INVENTION

The present disclosure relates to brand analysis and marketing, and more particularly to a method and system for extracting demand enhancing attributes from brand imagery for driving equity and sales through product differentiation.

### BACKGROUND

Brand perception and positioning play a crucial role in driving consumer behavior and market success. Companies invest significant resources in developing and maintaining brand identities that resonate with their target audiences. However, understanding how consumers truly perceive a brand and its attributes remains a complex challenge for marketers and brand managers.

Traditional methods of brand analysis often rely on qualitative research techniques or limited quantitative metrics that may not fully capture the nuanced associations consumers have with a brand. Additionally, these approaches may struggle to identify which specific brand attributes are most effective at differentiating a product or driving sales in a competitive marketplace.

The increasing availability of consumer survey data presents an opportunity for more sophisticated analysis of brand perceptions. However, extracting meaningful insights from large datasets of consumer responses can be difficult without appropriate analytical tools and methodologies. There is a need for improved techniques that can systematically process survey data to reveal key brand attributes and their relative importance.

Furthermore, brand perceptions and market dynamics can shift over time, necessitating ongoing monitoring and analysis. Brands must continually reassess their positioning and attributes to maintain relevance and competitive advantage. Methods that allow for efficient, repeatable analysis of brand imagery could provide valuable strategic guidance to marketing teams.

Effective product differentiation is another persistent challenge for many brands, particularly in crowded market segments. Identifying unique attributes that set a brand apart from competitors, while still maintaining core category expectations, requires a nuanced understanding of both the brand's strengths and the competitive landscape.

As markets become increasingly global, accounting for regional and cultural differences in brand perception adds another layer of complexity to brand analysis and strategy. Tools that can provide insights across different demographic segments and geographic markets are increasingly valuable for international brands.

Improved methods for extracting and analyzing demand-enhancing attributes from brand imagery data could help address many of these challenges facing modern brand management. Such techniques have the potential to bridge gaps between manufacturer intent and consumer perception, inform more effective brand positioning, and ultimately drive brand equity, sales, and customer loyalty.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for extracting demand enhancing attributes from brand imagery for driving equity and sales through product differentiation is provided. The method includes receiving consumer data using a consumer survey on a representative sample of a target population, wherein the consumer survey captures data on usage, awareness, and associations of multiple brands within a product category. The method further includes regressing the data on usage on brand imagery statements for each brand, wherein the data on usage and brand imagery statements are converted to numerical values. The method also includes applying LASSO regression to extract brand attributes that separate a user from a non-user, and sorting the attributes based on regression coefficients to determine their effectiveness in driving sales.

According to other aspects of the present disclosure, the method may include one or more of the following features. The method may further comprise comparing the attributes across brands to derive hygiene attributes, common attributes with key competitors, and differentiator attributes. The hygiene attributes may be a set of attributes common across major players in the product category. The common attributes with key competitors may be attributes that consumers associate with the brand and its primary competitors. The differentiator attributes may be attributes that consumers associate only with the brand and not with its competitors. The method may also include visualizing the results in a pyramid form, with the hygiene attributes as a bottom layer, the common attributes with key competitors as a middle layer, and the differentiator attributes as a top layer.

According to another aspect of the present disclosure, the method may further comprise receiving updated consumer data collected by periodically conducting the consumer survey to monitor changes in consumer perceptions over time. The method may also include applying the extracted demand enhancing attributes to drive product differentiation and growth.

According to other aspects of the present disclosure, the consumer survey may capture details on a focal brand and other brands, including key competitors, within the product category. The method may be applied to brands from different domains and across different markets. The method may also include bridging a gap between manufacturers' perception and consumer perception of a brand, and helping in brand positioning and creating narratives based on the key attributes.

### BRIEF DESCRIPTION OF DRAWINGS

The foregoing general description of the illustrative embodiments and the following detailed description thereof are merely exemplary aspects of the teachings of this disclosure and are not restrictive.

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of method steps for extracting demand enhancing attributes, in accordance with an embodiment of the present disclosure.

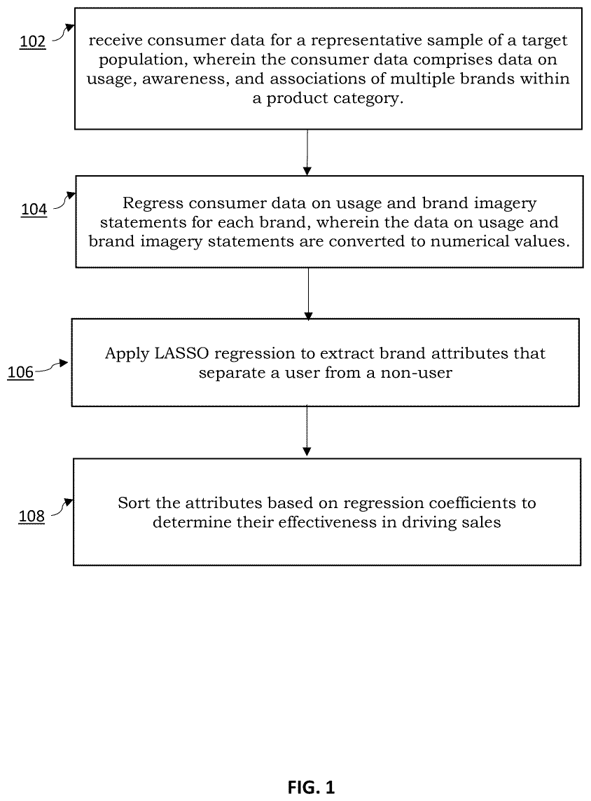

FIG. 2 is a schematic illustration of the system for extracting demand enhancing attributes, in accordance with an embodiment of the present disclosure;

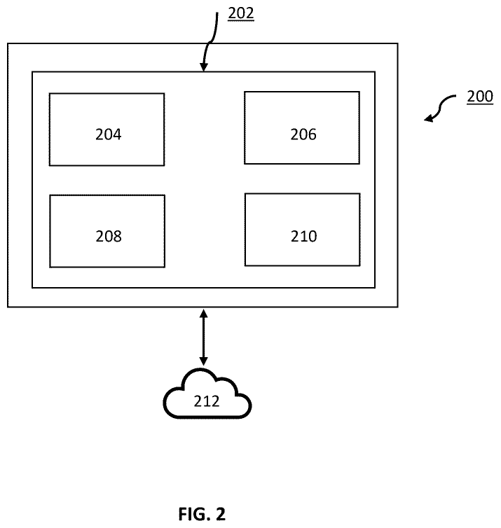

In the accompanying drawings, an underlined number is employed to represent a material over which the underlined number is positioned or a material to which the underlined number is adjacent. A non-underlined number relates to a material identified by a line linking the non-underlined number to the material. When a number is non-underlined and accompanied by an associated arrow, the nonunderlined number is used to identify a general material at which the arrow is pointing.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a method for extracting demand enhancing attributes from brand imagery with the aim of driving equity and sales through product differentiation. This method offers a systematic approach to understanding consumer perceptions of a brand and its associated attributes, and leverages this understanding to inform brand positioning and differentiation strategies. The method involves receiving consumer data on brand usage, awareness, and associations within a product category wherein the consumer data is collected by conducting a consumer survey. This consumer data is then processed using regression techniques to identify key brand attributes that differentiate users from non-users. The identified attributes are further analyzed and categorized into hygiene attributes, common attributes with key competitors, and differentiator attributes. This categorization provides a nuanced understanding of the brand's position in the market and its unique selling points. The method also allows for periodic reassessment of consumer perceptions and brand attributes, enabling brands to adapt to changing market dynamics and consumer preferences. In some aspects, the method may be applied across different markets and product categories, offering valuable insights for both local and global brand strategies.

In some aspects, the method for extracting demand enhancing attributes from brand imagery may begin with receiving the consumer data collected through a survey. This survey may be conducted on a representative sample of the target population, and may include questions on demographics, socio-economic status, brand awareness, brand usage, and brand associations with attributes or imagery statements. The survey may capture details on the focal brand and other brands within its category, including its key competitors. In some cases, the survey may be conducted periodically to monitor changes in brand health and key performance indicators over time.

Once the consumer data is collected, it may be processed using regression techniques. In some aspects, the consumer data on brand usage may be regressed on brand imagery statements. The responses to these statements, which may be in the form of “yes” or “no”, may be converted to numerical values, such as 1's and 0's, through a process known as categorical variable coding or one-hot encoding. In some cases, LASSO regression may be applied to extract the brand attributes that differentiate a user from a non-user. The regression coefficients may then be used to rank the attributes based on their effectiveness in driving sales.

Following the regression analysis, the identified attributes may be categorized into different layers. In some aspects, these layers may include hygiene attributes, which are common across major players in the category; common attributes with key competitors, which are shared by the focal brand and its primary competitors; and differentiator attributes, which are unique to the focal brand. This categorization may provide a comprehensive understanding of the brand's position in the market and its unique selling points.

In a primary embodiment of the present invention, the method of extracting demand enhancing attributes comprises several steps executed by a processor communicably connected with a memory device. At step 102, consumer data is received by a processor wherein consumer data is obtained by a survey conducted on a representative sample of a target population, wherein the survey captures data on usage, awareness, and associations of multiple brands within a product category. At a step 104, the consumer data is regressed, by the processor, on usage and brand imagery statements for each brand, wherein the consumer data on usage and brand imagery statements are converted to numerical values. At a step 106, LASSO regression is applied by the processor to extract brand attributes that separates a user from a non-user. At a step 108, the attributes are sorted by the processor based on regression coefficients to determine their effectiveness in driving sales.

In some cases, the results of the attribute categorization may be visualized in a pyramid form, with the hygiene attributes forming the base or bottom layer, the common attributes with key competitors forming the middle layer, and the differentiator attributes forming the top layer. This visualization may provide a clear and intuitive representation of the brand's market position and differentiation strategy.

In some aspects, the method may also account for potential changes in consumer perceptions over time. This may be achieved by receiving updated consumer data collected by conducting the consumer survey and attribute categorization process periodically, and comparing the results across different time periods. In this way, the method may enable brands to adapt to changing market dynamics and consumer preferences.

In some cases, the method may be applied to multiple brands within a single product category. This may allow for a comparative analysis of the brands' market positions and differentiation strategies. In other cases, the method may be applied across different markets or product categories, providing valuable insights for both local and global brand strategies.

Another embodiment of the present invention discloses a system 200 for extracting demand enhancing attributes, wherein the system 200 comprises a processor 202 communicably coupled to a memory device 212 wherein the processor further comprises a survey module 204, a data processing module 206, a regression module 208 and an analysis module 210.

In an aspect of the present invention, consumer data is received by the processor 202, using the survey module 204. The consumer data is collected by conducting consumer survey periodically to monitor brand health and key performance indicators. The frequency of these surveys may vary depending on the industry or the specific needs of the brand. For instance, some brands may choose to conduct surveys on a weekly basis, while others may opt for quarterly surveys. This periodicity allows for a continuous stream of data, providing a dynamic view of consumer perceptions and brand performance over time.

In some cases, the consumer survey may be conducted by a market research agency in partnership with the brand. The agency may use statistical sampling procedures, such as simple random sampling or stratified random sampling, to ensure that the sample is representative of the target population. This representative sample may provide a more accurate reflection of the broader consumer perceptions and associations with the brand.

In other aspects, the consumer survey may include a variety of questions designed to capture a comprehensive view of the consumer's relationship with the brand. These questions may cover demographics, socio-economic status, brand awareness, recent brand usage, and brand associations with various attributes or imagery statements. The survey may also capture details on other brands within the same category, including key competitors of the focal brand. This breadth of data may provide a rich source of information for the subsequent analysis and attribute extraction process.

In some cases, the consumer survey may be designed to ensure the accuracy and reliability of the responses. For instance, the market research agency conducting the survey may perform data cleaning and reliability checks. If a bias is detected in a consumer's responses, such as giving the same rating to all questions, that consumer's data may be removed from further analysis. This process may help to maintain the integrity of the survey data and ensure that the subsequent analysis is based on reliable and accurate information.

In some aspects, the consumer survey may be designed to capture data on multiple brands within a product category. This may include the focal brand, which is the primary subject of the survey, as well as other brands that are considered key competitors. The survey may ask respondents about their usage of these brands, their awareness of these brands, and their associations with various attributes or imagery statements related to these brands. This multi-brand approach may provide a comparative view of the market, allowing for a more nuanced understanding of the focal brand's position relative to its competitors.

In some cases, the survey may ask respondents about their usage of the brands in the recent past, such as the past four weeks. This may provide a snapshot of the current market dynamics, capturing recent shifts in consumer behavior and brand performance. The survey may also ask respondents about their awareness of the brands, gauging the reach and visibility of the brands in the market. This may include questions about the respondents' familiarity with the brands, their recall of brand advertisements, and their knowledge of brand products or services.

In other aspects, the survey may ask respondents about their associations with various attributes or imagery statements related to the brands. These attributes may encompass a wide range of characteristics, such as safety features, superior technology, attractive design, better resale value, and a good network of service centers, among others. The respondents may be asked to indicate whether they associate each attribute with each brand, providing a “yes” or “no” response. This data may provide insights into the brand imagery, revealing the attributes that consumers associate with each brand and potentially highlighting areas of differentiation.

In some cases, the consumer survey may be conducted periodically to collect updated customer data, allowing for the monitoring of changes in brand health and key performance indicators over time. This may enable the tracking of shifts in consumer perceptions and brand associations, providing valuable insights for brand positioning and differentiation strategies. The frequency of these surveys may vary depending on the industry or the specific needs of the brand, with some brands opting for weekly surveys and others opting for quarterly surveys.

In other cases, the consumer survey may be designed to capture data on multiple brands across different markets. This may allow for a comparative analysis of the brands' market positions and differentiation strategies in different geographical or cultural contexts. This approach may provide valuable insights for global brand strategies, helping brands to adapt to regional differences in consumer perceptions and brand associations.

In another aspect of the present invention, the processor 202 is configured to perform regression, using the regression module 208, on the consumer data on brand usage on brand imagery statements for each brand using the regression module 208. This regression may be performed using a variety of techniques, with LASSO regression being one possible approach. LASSO regression, or Least Absolute Shrinkage and Selection Operator regression, is a type of regression analysis that is particularly useful when dealing with a large number of predictor variables, as it can help to prevent overfitting and improve the interpretability of the model by reducing the number of variables included in the final model.

In an aspect of the present invention, the consumer data on brand usage may be binary, consisting of “yes” and “no” responses indicating whether a respondent has used a particular brand. Similarly, the brand imagery statements may also be binary, with “yes” and “no” responses indicating whether a respondent associates a particular attribute with a brand. These binary responses may be converted to numerical values, such as 1's and 0's, through a process known as categorical variable coding or one-hot encoding. This conversion may facilitate the regression analysis by allowing the responses to be treated as numerical data.

In yet another aspect of the present invention, the regression analysis may be performed separately for each brand. This may allow for a more detailed understanding of the attributes associated with each brand, as well as the attributes that differentiate users from non-users. The regression coefficients obtained from the analysis may be used by the processor 202 to sort the attributes, using the analysis module 210, based on their effectiveness in driving sales. For instance, attributes with larger coefficients may be considered more effective in differentiating users from non-users, and thus more important in driving sales.

In other cases, the regression analysis may be performed using a pooled data set that includes data on multiple brands. This approach may provide a broader view of the market, allowing for a comparison of the attributes associated with different brands. The regression coefficients obtained from this analysis may be used to identify common attributes across brands, as well as attributes that differentiate one brand from another.

In some aspects, the regression analysis may be performed periodically, on updated consumer data allowing for the tracking of changes in brand attributes and consumer perceptions over time. This may enable brands to adapt their positioning and differentiation strategies in response to changing market dynamics and consumer preferences. For instance, if an attribute that was previously considered a differentiator becomes common across brands, the brand may need to identify new differentiators to maintain its unique market position.

In some aspects, the method may involve converting the responses to the survey questions into a format suitable for regression analysis. This may involve transforming the “yes” and “no” responses into numerical values, such as 1's and 0's. This process, known as categorical variable coding or one-hot encoding, may facilitate the handling of categorical data in the regression analysis. For instance, a “yes” response may be coded as “1”, indicating the presence of a particular attribute or the usage of a brand, while a “no” response may be coded as “0”, indicating the absence of the attribute or non-usage of the brand.

In some cases, the conversion of “yes” and “no” responses to 1's and 0's may be performed for all the survey questions related to brand usage and brand imagery statements. This may include questions about the respondent's usage of the focal brand and its competitors, as well as their associations with various attributes or imagery statements. The converted data may then be used as input for the regression analysis, with the numerical values representing the presence or absence of brand usage and attribute associations.

In other aspects, the conversion process may be applied to the responses of all respondents in the survey. This may ensure that the data from all respondents is in a consistent format, facilitating the comparison and analysis of responses across different respondents. The converted data may then be used to identify patterns and trends in brand usage and attribute associations, providing insights into consumer perceptions and preferences.

In some cases, the conversion process may be automated using software or algorithms. This may help to ensure the accuracy and consistency of the conversion process, reducing the risk of errors or inconsistencies in the converted data. The automated process may also facilitate the handling of large volumes of survey data, enabling the analysis of responses from a large number of respondents.

In other cases, the conversion process may be performed by the processor 202 using the data processing module 206 as part of the data preprocessing stage, prior to the regression analysis. This may involve cleaning the data, removing outliers or inconsistencies, and transforming the responses into a suitable format for analysis. The preprocessing stage may help to ensure that the data is in a suitable state for the subsequent analysis, improving the accuracy and reliability of the results.

In some aspects, the method may involve the application of LASSO regression specifically to extract brand attributes that differentiate users from non-users. LASSO regression, or Least Absolute Shrinkage and Selection Operator regression, is a type of regression analysis that is particularly useful when dealing with a large number of predictor variables. It can help to prevent overfitting and improve the interpretability of the model by reducing the number of variables included in the final model.

In some cases, the LASSO regression may be applied by the processor 202 to the consumer data on brand usage and brand imagery statements. The consumer data on brand usage, which may consist of “yes” and “no” responses indicating whether a respondent has used a particular brand, may be regressed on the brand imagery statements. These brand imagery statements may also consist of “yes” and “no” responses, indicating whether a respondent associates a particular attribute with a brand.

In other aspects, the LASSO regression may be used by the processor 202 to extract the brand attributes that separate users from non-users. This may involve identifying the attributes that are most strongly associated with brand usage, as indicated by the regression coefficients. The attributes with larger coefficients may be considered more effective in differentiating users from non-users, and thus more important in driving sales.

In some cases, the LASSO regression may be applied by the processor 202 to the data on multiple brands within a product category. This may allow for a comparative analysis of the attributes associated with different brands, and the identification of attributes that differentiate one brand from another.

In other aspects, the LASSO regression may be performed by the processor 202 periodically on the updated consumer data, allowing for the tracking of changes in brand attributes and consumer perceptions over time. This may enable brands to adapt their positioning and differentiation strategies in response to changing market dynamics and consumer preferences.

In some cases, the LASSO regression may be performed by the processor 202 on a pooled data set that includes data on multiple brands. This approach may provide a broader view of the market, allowing for a comparison of the attributes associated with different brands. The regression coefficients obtained from this analysis may be used to identify common attributes across brands, as well as attributes that differentiate one brand from another.

In other aspects, the LASSO regression may be performed by the processor 202 separately for each brand. This may allow for a more detailed understanding of the attributes associated with each brand, as well as the attributes that differentiate users from non-users. The regression coefficients obtained from the analysis may be used by the processor 202 to sort the attributes, using the analysis module 210, based on their effectiveness in driving sales.

In some cases, the LASSO regression may be performed using a software or algorithm. This may help to ensure the accuracy and consistency of the regression analysis, reducing the risk of errors or inconsistencies in the results. The software or algorithm may also facilitate the handling of large volumes of survey data, enabling the analysis of responses from a large number of respondents.

In yet another aspect of the present invention, the method further comprises interpreting, by the processor 202, the coefficients from the LASSO regression in terms of odds ratio. The odds ratio may be understood as the ratio of the odds of an imagery attribute being favored by a user to the odds of the same attribute being favored by a non-user. This interpretation may provide a measure of the effectiveness of each attribute in differentiating users from non-users, and thus in driving sales.

In some cases, an odds ratio threshold may be set to determine the key attributes. For instance, if the odds ratio for an attribute is above a certain threshold, such as 20%, then that attribute may be chosen as a key attribute. This threshold may serve as a criterion for selecting the attributes that are most effective in differentiating users from non-users. The selected attributes may then be ranked based on their odds ratios, with attributes having higher odds ratios considered more effective in driving sales.

In other aspects, the odds ratio threshold may be adjusted based on the specific needs or objectives of the brand. For instance, a brand may choose to set a higher threshold if it wants to focus on a smaller set of highly effective attributes, or a lower threshold if it wants to consider a broader range of attributes. This flexibility may allow the method to be tailored to the specific needs and objectives of each brand.

In some cases, the odds ratio may be calculated for each attribute for each brand. This may allow for a comparative analysis of the effectiveness of different attributes across different brands. The results of this analysis may provide insights into the unique selling points of each brand, as well as the common attributes across brands.

In other aspects, the odds ratio may be calculated periodically, allowing for the tracking of changes in the effectiveness of different attributes over time. This may enable brands to adapt their positioning and differentiation strategies in response to changing consumer perceptions and market dynamics. For instance, if an attribute that was previously considered a key differentiator becomes less effective over time, the brand may need to identify new differentiators to maintain its unique market position.

In another aspect of the present invention, the method may involve comparing, by the processor 202, the attributes across brands to derive hygiene attributes, common attributes with key competitors, and differentiator attributes. This comparison may be based on the results of the LASSO regression analysis, which identifies the key attributes associated with each brand. The attributes may be categorized into different layers based on their prevalence and significance across the brands.

In some cases, the hygiene attributes may be identified as a set of attributes that are common across major players in the product category. These attributes may be considered as “must have” attributes that consumers expect from any brand within the category. For instance, in the automobile industry, safety features may be considered as hygiene attributes, as they are expected by consumers from all car brands.

In other aspects, the common attributes with key competitors may be identified as the next layer of attributes. These attributes may be shared by the focal brand and its primary competitors, indicating a level of parity in the market. For example, superior technology may be a common attribute among high-end car brands, reflecting their shared focus on technological innovation.

In some cases, the differentiator attributes may be identified as the final layer of attributes. These attributes may be unique to the focal brand and not associated with its competitors by the consumers. These attributes may allow the brand to stand out among its competitors and drive product differentiation. For instance, a unique design aesthetic may be a differentiator attribute for a car brand, distinguishing it from other brands in the market.

In other aspects, the processor 202 performs categorization of attributes into hygiene, common with key competitors, and differentiator layers may be performed using a variety of techniques. For instance, intersection analysis may be used to identify common attributes across brands, while exclusive attributes may be identified through a process of elimination. The categorization process may be automated using software or algorithms, facilitating the handling of large volumes of attribute data.

In other aspects, the attribute categorization process may be performed periodically on the updated consumer data, allowing for the tracking of changes in brand attributes and consumer perceptions over time. This may enable brands to adapt their positioning and differentiation strategies in response to changing market dynamics and consumer preferences. For instance, if an attribute that was previously considered a differentiator becomes common across brands, the brand may need to identify new differentiators to maintain its unique market position.

In some aspects, the results of the attribute categorization may be visualized in a pyramid form. This pyramid visualization may provide a clear and intuitive representation of the brand's market position and differentiation strategy. The pyramid may consist of three layers, each representing a different category of attributes. The base or bottom layer of the pyramid may represent the hygiene attributes, which are common across major players in the product category. These attributes may be considered as “must have” attributes that consumers expect from any brand within the category.

In some cases, the middle layer of the pyramid may represent the common attributes with key competitors. These attributes may be shared by the focal brand and its primary competitors, indicating a level of parity in the market. The common attributes may provide insights into the shared strengths of the leading brands in the category, as well as potential areas of competition.

In other aspects, the top layer of the pyramid may represent the differentiator attributes. These attributes may be unique to the focal brand and not associated with its competitors by the consumers. The differentiator attributes may highlight the unique selling points of the brand, providing insights into its unique market position and potential areas of competitive advantage.

The hygiene attributes may form the base or bottom layer of the pyramid, reflecting their foundational role in the product category. The common attributes with key competitors may form the middle layer, indicating their shared significance among the leading brands. The differentiator attributes may form the top layer of the pyramid, highlighting their unique role in driving product differentiation and brand equity.

In some cases, the pyramid visualization may be updated periodically to reflect changes in brand attributes and consumer perceptions over time. This may enable brands to adapt their positioning and differentiation strategies in response to changing market dynamics and consumer preferences. For instance, if an attribute that was previously considered a differentiator becomes common across brands, the brand may need to adjust its pyramid visualization to reflect this change.

In other aspects, the pyramid visualization may be used to compare the brand attributes of multiple brands within a single product category. This may provide a comparative view of the market, highlighting the shared and unique attributes of different brands. The pyramid visualization may also be used to compare the brand attributes of a single brand across different markets or product categories, providing insights into regional or category-specific differences in brand perceptions.

In some aspects, the method may involve receiving updated consumer data collected by periodically conducting consumer surveys to monitor changes in consumer perceptions over time. This periodicity may allow for a continuous stream of data, providing a dynamic view of consumer perceptions and brand performance. The frequency of these surveys may vary depending on the industry or the specific needs of the brand. For instance, some brands may choose to conduct surveys on a weekly basis, while others may opt for quarterly surveys.

In some cases, the method may involve comparing the results of the attribute categorization process across different time periods. This comparison may be facilitated by the pyramid visualization, which provides a clear and intuitive representation of the brand's market position and differentiation strategy. By comparing the pyramids from different time periods, brands may be able to identify changes in consumer perceptions and adjust their positioning and differentiation strategies accordingly.

For instance, if an attribute that was previously considered a differentiator becomes common across brands, the brand may need to adjust its pyramid visualization to reflect this change. Similarly, if a new attribute emerges as a differentiator, the brand may need to update its pyramid visualization to include this attribute. This dynamic approach to attribute categorization and visualization may enable brands to adapt to changing market dynamics and consumer preferences, ensuring that their positioning and differentiation strategies remain relevant and effective.

In other aspects, the method may involve receiving updated consumer data collected by conducting the consumer survey and attribute categorization process periodically, and comparing the results across different time periods. This may enable brands to track shifts in consumer perceptions and brand associations, providing valuable insights for brand positioning and differentiation strategies. The comparison of pyramids across different time periods may reveal trends in consumer perceptions, highlighting the attributes that are gaining or losing importance over time.

In some cases, the method may involve the use of software or algorithms to automate the comparison of pyramids across different time periods. This may facilitate the handling of large volumes of survey data and attribute categorization results, enabling the analysis of trends and changes in consumer perceptions over time. The automated comparison process may also ensure the accuracy and consistency of the comparison, reducing the risk of errors or inconsistencies in the results.

In other aspects, the method may involve the use of statistical tests or measures to validate the results of the attribute categorization and comparison process. These tests or measures may help to ensure the reliability of the results, providing a robust basis for brand positioning and differentiation strategies. The validation process may be performed periodically, along with the consumer survey and attribute categorization process, ensuring that the results remain valid and reliable over time.

In some aspects, the extracted demand enhancing attributes may be applied to drive product differentiation and growth. For instance, the attributes identified as differentiators may be leveraged to create a unique brand positioning that sets the brand apart from its competitors. This unique positioning may be communicated to consumers through various marketing channels, helping to shape consumer perceptions and drive brand equity and sales.

In some cases, the attributes identified as common with key competitors may be used to inform competitive strategies. For instance, a brand may choose to focus on improving or innovating these common attributes to gain a competitive edge. Alternatively, a brand may choose to de-emphasize these common attributes in its marketing communications, instead focusing on its unique differentiators to distinguish itself from its competitors.

In other aspects, the attributes identified as hygiene attributes may be used to ensure that the brand meets the basic expectations of consumers in the product category. These hygiene attributes may be considered as a baseline for participation in the category, and failing to meet these expectations may negatively impact brand equity and sales. Therefore, brands may focus on maintaining or improving these hygiene attributes to ensure a positive consumer perception.

In some cases, the extracted demand enhancing attributes may be used to inform product development strategies. For instance, a brand may choose to develop new products or features that align with its differentiator attributes, reinforcing its unique positioning in the market. Alternatively, a brand may choose to improve its products or features related to its hygiene attributes, ensuring that it meets the basic expectations of consumers.

In other aspects, the extracted demand enhancing attributes may be used to inform pricing strategies. For instance, a brand may choose to price its products higher if it has strong differentiator attributes that consumers value highly. Alternatively, a brand may choose to price its products competitively if it has strong common attributes with key competitors, aiming to compete on price in addition to these common attributes.

In some cases, the extracted demand enhancing attributes may be used to inform distribution strategies. For instance, a brand may choose to distribute its products in channels that align with its differentiator attributes, reinforcing its unique positioning. Alternatively, a brand may choose to distribute its products widely to ensure that it meets the basic expectations of consumers related to its hygiene attributes.

In other aspects, the extracted demand enhancing attributes may be used to inform customer service strategies. For instance, a brand may choose to provide superior customer service if this is identified as a differentiator attribute. Alternatively, a brand may choose to focus on improving its customer service related to its hygiene attributes, ensuring that it meets the basic expectations of consumers.

In some cases, the extracted demand enhancing attributes may be used to inform branding and communication strategies. For instance, a brand may choose to emphasize its differentiator attributes in its branding and communications, helping to shape consumer perceptions and drive brand equity and sales. Alternatively, a brand may choose to communicate its commitment to its hygiene attributes, reinforcing its credibility and trustworthiness in the eyes of consumers.

In some aspects, the method may serve as a bridge between manufacturers' perception and consumer perception of a brand. This bridging function may be achieved through the systematic extraction and analysis of demand enhancing attributes from brand imagery. By identifying the attributes that consumers associate with a brand and those that drive product differentiation and growth, the method may provide manufacturers with a clearer understanding of consumer perceptions. This understanding may help manufacturers to align their brand positioning and differentiation strategies with consumer perceptions, potentially driving brand equity, sales, and loyalty.

In some cases, the method may involve receiving consumer data collected by conducting a consumer survey to gather data on brand usage, awareness, and associations. This survey data may provide insights into the attributes that consumers associate with a brand, which may differ from the attributes that manufacturers believe are associated with the brand. By comparing these consumer-derived attributes with the manufacturers' perceptions, the method may help to identify gaps or misalignments in brand positioning.

In other aspects, the method may involve the use of regression techniques to identify key brand attributes that differentiate users from non-users. These key attributes may provide a measure of the brand's effectiveness in driving product differentiation and growth. By comparing these key attributes with the manufacturers' perceptions, the method may help to identify areas where the brand's positioning could be improved to better align with consumer perceptions.

In some cases, the method may involve the categorization of attributes into hygiene attributes, common attributes with key competitors, and differentiator attributes. This categorization may provide a nuanced understanding of the brand's position in the market and its unique selling points. By comparing these categorized attributes with the manufacturers' perceptions, the method may help to identify areas where the brand's differentiation strategy could be improved to better align with consumer perceptions.

In other aspects, the method may involve the visualization of the categorized attributes in a pyramid form. This visualization may provide a clear and intuitive representation of the brand's market position and differentiation strategy. By comparing this visualization with the manufacturers' perceptions, the method may help to identify areas where the brand's communication strategy could be improved to better align with consumer perceptions.

In some cases, the method may involve the periodic reassessment of consumer perceptions and brand attributes. This reassessment may enable brands to adapt to changing market dynamics and consumer preferences, ensuring that their positioning and differentiation strategies remain relevant and effective. By comparing the results of these periodic reassessments with the manufacturers' perceptions, the method may help to identify areas where the brand's strategy could be adjusted to better align with evolving consumer perceptions.

In some aspects, the method may assist in brand positioning by identifying the key attributes that consumers associate with a brand. These attributes, which may be extracted from brand imagery through a systematic process of data collection, regression analysis, and attribute categorization, may provide valuable insights into the brand's unique selling points and market position. By aligning the brand's positioning with these consumer-derived attributes, the method may help to enhance brand equity, drive sales, and foster consumer loyalty.

In some cases, the method may assist in creating narratives based on the key attributes. These narratives, which may be crafted around the hygiene attributes, common attributes with key competitors, and differentiator attributes, may serve to communicate the brand's unique value proposition to consumers. For instance, a narrative based on a differentiator attribute may highlight the brand's unique strengths and capabilities, setting it apart from its competitors. Similarly, a narrative based on a hygiene attribute may reinforce the brand's commitment to meeting the basic expectations of consumers in the product category.

In other aspects, the method may assist in brand positioning by identifying the attributes that drive product differentiation and growth. These attributes, which may be identified through regression analysis of brand usage and brand imagery data, may provide a measure of the brand's effectiveness in differentiating itself from its competitors. By aligning the brand's positioning with these key attributes, the method may help to enhance the brand's competitive advantage and drive market growth.

In some cases, the method may assist in creating narratives based on the attributes that drive product differentiation and growth. These narratives, which may be crafted around the key attributes identified through the method, may serve to communicate the brand's unique value proposition to consumers. For instance, a narrative based on an attribute that drives product differentiation may highlight the brand's innovative capabilities, setting it apart from its competitors. Similarly, a narrative based on an attribute that drives growth may reinforce the brand's commitment to delivering value to consumers, driving brand loyalty and market expansion.

In other aspects, the method may assist in brand positioning and narrative creation by providing a clear and intuitive visualization of the brand's market position and differentiation strategy. This visualization, which may take the form of a pyramid with hygiene attributes at the base, common attributes with key competitors in the middle, and differentiator attributes at the top, may provide a comprehensive view of the brand's unique selling points and competitive landscape. By aligning the brand's positioning and narratives with this visualization, the method may help to enhance the brand's communication strategy, ensuring that it resonates with consumer perceptions and drives brand equity and sales.

In some aspects, the method may be applied to brands from different domains. This may involve conducting consumer surveys and attribute categorization processes for brands in various industries or product categories. For instance, the method may be applied to brands in the automobile industry, the technology industry, the fashion industry, or any other industry. This cross-domain application may provide valuable insights into the unique attributes and consumer perceptions associated with brands in different domains, informing brand positioning and differentiation strategies across a wide range of industries.

In some cases, the method may be applied to brands across different markets. This may involve conducting consumer surveys and attribute categorization processes in various geographical or cultural contexts. For instance, the method may be applied to brands in the North American market, the European market, the Asian market, or any other market. This cross-market application may provide valuable insights into regional differences in brand perceptions and consumer preferences, informing both local and global brand strategies.

In other aspects, the method may be used to extract brand associations across different demographics. This may involve conducting consumer surveys among different demographic groups, such as different age groups, income levels, education levels, or any other demographic categories. The survey data may be analyzed to identify the attributes associated with a brand by consumers in each demographic group. This demographic-specific analysis may provide insights into the unique attributes and consumer perceptions associated with a brand among different demographic groups, informing targeted brand positioning and differentiation strategies.

In some cases, the method may be used to compare brand associations across different demographics. This may involve comparing the results of the attribute categorization process across different demographic groups. For instance, the method may reveal that certain attributes are more strongly associated with a brand by consumers in one demographic group compared to another. This comparison may provide insights into demographic differences in brand perceptions, informing targeted brand positioning and differentiation strategies.

In other aspects, the method may be used to track changes in brand associations across different demographics over time. This may involve conducting consumer surveys and attribute categorization processes periodically among different demographic groups, and comparing the results across different time periods. This longitudinal analysis may provide insights into trends and changes in brand perceptions among different demographic groups, informing dynamic brand positioning and differentiation strategies that adapt to changing consumer perceptions.

In some aspects, the method may be applied to a brand in the automobile industry. For instance, a consumer survey may be conducted among a representative sample of car buyers, asking questions about their usage of different car brands, their awareness of these brands, and their associations with various attributes such as safety features, fuel efficiency, design aesthetics, and technological innovation. The survey data may then be processed using LASSO regression to identify the key attributes that differentiate users of one car brand from users of other brands. These attributes may be categorized into hygiene attributes, common attributes with key competitors, and differentiator attributes, providing a nuanced understanding of the car brand's position in the market and its unique selling points.

In some cases, the method may be applied to a brand in the technology industry. For example, a consumer survey may be conducted among a representative sample of technology users, asking questions about their usage of different technology brands, their awareness of these brands, and their associations with various attributes such as user-friendliness, innovative features, reliability, and customer support. The survey data may then be processed using LASSO regression to identify the key attributes that differentiate users of one technology brand from users of other brands. These attributes may be categorized into hygiene attributes, common attributes with key competitors, and differentiator attributes, providing a nuanced understanding of the technology brand's position in the market and its unique selling points.

In other aspects, the method may be applied to a brand in the fashion industry. For instance, a consumer survey may be conducted among a representative sample of fashion consumers, asking questions about their usage of different fashion brands, their awareness of these brands, and their associations with various attributes such as style, quality, price, and sustainability. The survey data may then be processed using LASSO regression to identify the key attributes that differentiate users of one fashion brand from users of other brands. These attributes may be categorized into hygiene attributes, common attributes with key competitors, and differentiator attributes, providing a nuanced understanding of the fashion brand's position in the market and its unique selling points.

In some cases, the method may be applied to a brand in the food and beverage industry. For example, a consumer survey may be conducted among a representative sample of food and beverage consumers, asking questions about their usage of different food and beverage brands, their awareness of these brands, and their associations with various attributes such as taste, nutritional value, price, and packaging. The survey data may then be processed using LASSO regression to identify the key attributes that differentiate users of one food and beverage brand from users of other brands. These attributes may be categorized into hygiene attributes, common attributes with key competitors, and differentiator attributes, providing a nuanced understanding of the food and beverage brand's position in the market and its unique selling points.

In other aspects, the method may be applied to a brand in the healthcare industry. For instance, a consumer survey may be conducted among a representative sample of healthcare consumers, asking questions about their usage of different healthcare brands, their awareness of these brands, and their associations with various attributes such as effectiveness, safety, price, and accessibility. The survey data may then be processed using LASSO regression to identify the key attributes that differentiate users of one healthcare brand from users of other brands. These attributes may be categorized into hygiene attributes, common attributes with key competitors, and differentiator attributes, providing a nuanced understanding of the healthcare brand's position in the market and its unique selling points.

In each of these scenarios, the method may provide valuable insights into consumer perceptions of the brand and its associated attributes, informing brand positioning and differentiation strategies. The method may also allow for periodic reassessment of consumer perceptions and brand attributes, enabling brands to adapt to changing market dynamics and consumer preferences.

A number of implementations have been described. Nevertheless, it will be understood that various modifications may be made without departing from the spirit and scope of the disclosure. Accordingly, other implementations are within the scope of the following claims.

Various operations and methods have been described. Some methods have been described by way of flow chart in a relatively basic manner, but these operations can optionally be added to and/or removed from these methods. In addition, although the flowchart shows specific sequences of operations according to various exemplary examples, it is to be understood that the specific sequences are exemplary. Alternative examples may optionally perform these operations in different ways, combine certain operations, interlace some operations, etc. The modules, features, and specific optional details of the devices described herein may also optionally be applied to the methods described herein. In various examples, these methods may be executed by and/or executed within such devices.

In the present disclosure, respective functional parts/units/sub-units/modules/sub-modules/means may be hardware. For instance, the hardware may be a circuit including a digital circuit, an analog circuit, and the like. Physical implementation of hardware structures may include, but is not limited to, physical devices, and the physical devices may include but are not limited to transistors, memristors, and the like. The processor may be any suitable hardware processor such as a CPU, GPU, FPGA, DSP, ASIC, etc. The memory may be any suitable magnetic storage medium or magneto-optical storage medium such as RRAM, DRAM, SRAM, EDRAM, HBM, HMC, etc.

Persons skilled in the art can clearly understand that for convenience and conciseness of description, the division of the above-mentioned functional modules is illustrated only as instances, and in practical application, the above-mentioned functions can be assigned to different functional modules to complete according to the needs. In other words, the internal structure of the device can be divided into different functional modules to complete all or a part of the functions described above.

The specific examples described above further explain the purpose, technical solution, and technical effects of the present disclosure in detail. It should be understood that the above description only relates to specific examples of the present disclosure and is not intended to limit the present disclosure, and any modifications, equivalent substitutions, improvements, etc. made within the spirit and principles of the present disclosure should all be included within the scope of protection of the present disclosure.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components. A computer system can include a plurality of the components or subsystems, e.g., connected together by external interface or by an internal interface.

In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or modules or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

1. A method for extracting demand enhancing attributes from brand imagery, comprising:
receiving consumer data for a representative sample of a target population, wherein the consumer data comprises data on usage, awareness, and associations of multiple brands within a product category;
regressing the consumer data on usage and brand imagery statements for each brand, wherein the data on usage and brand imagery statements are converted to numerical values;
applying LASSO regression to extract brand attributes that separate a user from a non-user; and
sorting the attributes based on regression coefficients to determine their effectiveness in driving sales.

2. The method of claim 1, further comprising comparing the attributes across brands to derive hygiene attributes, common attributes with key competitors, and differentiator attributes.

3. The method of claim 2, wherein the hygiene attributes are a set of attributes common across major players in the product category.

4. The method of claim 2, wherein the common attributes with key competitors are attributes that consumers associate with the brand and its primary competitors.

5. The method of claim 2, wherein the differentiator attributes are attributes that consumers associate only with the brand and not with its competitors.

6. The method of claim 2, further comprising visualizing the results in a pyramid form, with the hygiene attributes as a bottom layer, the common attributes with key competitors as a middle layer, and the differentiator attributes as a top layer.

7. The method of claim 1, further comprising receiving updated consumer data collected by periodically conducting the consumer survey to monitor changes in consumer perceptions over time.

8. A system for extracting demand enhancing attributes from brand imagery, comprising:
a survey module configured to receive consumer data for a representative sample of a target population, wherein the consumer data comprises data on usage, awareness, and associations of multiple brands within a product category;
a data processing module configured to convert the consumer data on usage and brand imagery statements to numerical values;
a regression module configured to apply LASSO regression to extract brand attributes that separate a user from a non-user; and
an analysis module configured to sort the attributes based on regression coefficients to determine their effectiveness in driving sales.

9. The system of claim 8, further comprising a comparison module configured to compare the attributes across brands to derive hygiene attributes, common attributes with key competitors, and differentiator attributes.

10. The system of claim 9, wherein the hygiene attributes are a set of attributes common across major players in the product category.

11. The system of claim 9, wherein the common attributes with key competitors are attributes that consumers associate with the brand and its primary competitors.

12. The system of claim 9, wherein the differentiator attributes are attributes that consumers associate only with the brand and not with its competitors.

13. The system of claim 9, further comprising a visualization module configured to visualize the results in a pyramid form, with the hygiene attributes as a bottom layer, the common attributes with key competitors as a middle layer, and the differentiator attributes as a top layer.

14. The system of claim 8, wherein the survey module is further configured to receive updated consumer data collected by periodically conducting the consumer survey to monitor changes in consumer perceptions over time.
